(19) United States
(12) Patent Application Publication
(10) Pub. No.: US 2011/0036995 A1
(43) Pub. Date: Feb. 17, 2011

(54) PATHOGEN DETECTION BY SIMULTANEOUS SIZE/FLUORESCENCE MEASUREMENT

(75) Inventors: Erik H. Binnie, Tucson, AZ (US); GRegory Scott Morris, Tucson, AZ (US)

Correspondence Address: QUARLES & BRADY LLP, ONE SOUTH CHURCH AVENUE, SUITE 1700, TUCSON, AZ, 85701-1621, US

(73) Assignee: BIOVIGILANT SYSTEMS, INC., TUCSON, AZ (US)

(21) Appl. No.: 12/808,170

(22) PCT Filed: Dec. 15, 2008
(86) PCT No.: PCT/US08/86886

§ 371 Date: Nov. 4, 2010

Related U.S. Application Data
(60) Provisional application No. 61/013,607, filed on Dec. 13, 2007.

(51) Int. Cl. G01J 1/58; G01N 21/64; H01J 40/14

(52) U.S. Cl. 250/459.1; 250/458.1; 250/461.1; 250/200

(57) ABSTRACT

A method and apparatus for detecting pathogens and particles in a fluid in which particle size and intrinsic fluorescence of a simple particle is determined, comprising a sample cell; a light source on one side of the sample cell for sending a focused beam of light through the sample, whereby portions of the beam of light are scattered at various angles by particles of various sizes present in the sample area; a particle size detector positioned in the light path for detecting a portion of forward scattered light; a pair of fluorescence detectors positioned off axis from the beam of light; and a pair of elliptical mirrors positioned such that an intersection of the incoming particle stream and the light beam are at one foci of each ellipsoid, and one of said pair of fluorescence detectors lies at the other foci.

The present invention relates generally to a system and method for detecting airborne or liquid borne particles, and more particularly to a system and method for detecting airborne or liquid borne particles and classifying the detected particles. The invention has particular utility in detecting and classifying biological particles or contamination in clean environments such as aseptic manufacturing facilities, as well as other environments and will be described in connection with such utilities, although other utilities are contemplated.

The monitoring for environmental contamination, including biological particles, is important in a number of industrial and commercial environments such as manufacturing facilities for pharmaceuticals, food and hospitals, and has also become important in public spaces such as airports, banks, postal handling facilities and government offices where there is concern for possible urban terrorist attacks.

In the pharmaceutical, healthcare and food industries a real time detector of environmental biological particle levels is useful for public health, quality control and regulatory purposes. For example, parenteral drug manufacturers are required by the Food and Drug Administration to monitor the particulate and microbial levels in their aseptic clean rooms. Conventional microbiological methods require the collection of samples on growth media, and incubation at the correct temperature for the correct period of time (typically days). These methods assume that a viable microorganism is one that will undergo cellular division when placed in or on a growth media. For quantitative tests, growth is demonstrated by a visually detectable colony. There is a significant quantity of published literature that shows substantial limitations of using traditional culture and plate counting methods. For example, the published literature indicates variable results can be obtained depending upon the growth media used, the incubation time and temperature, and the condition of the microorganism prior to attempts to cultivate (e.g., slow growing, stressed, or sub-lethally damaged). Conventional methods also have no ability in real-time to locate probable sources of the contamination. In these applications, an instrument that can detect microbial particles, including bacteria, yeasts and molds, in the environment instantaneously and at low concentrations will be a useful tool and have significant advantages over conventional nutrient plate culture methods that require days for microbes to grow and be visually detected. It would also be useful to have an instrument that would be able to assist in locating, preferably in real-time, sources of particulate contamination.

There exist various prior art devices that employ particle size measurement and light induced fluorescence techniques as early warning sensors for bio-agents. Among these devices are Biological Agent Warning Sensor (BAWS) developed by MIT Lincoln Laboratory, fluorescence biological particle detection system of Ho (Jim Yew-Wah Ho, U.S. Pat. Nos. 5,701,012; 5,895,922; 6,831,279); FLAPS and UV-APS by TSI of Minnesota (Peter P. Hairston; and Frederick R. Quant; U.S. Pat. No. 5,999,250), and a fluorescence sensor by Silcott (U.S. Pat. No. 6,885,440). A proposed bio-sensor based on laser-induced fluorescence using a pulsed UV laser is described by T. H. Jeys, et al., Proc. IRIS Active Systems, vol. 1, p. 235, 1998. This is capable of detecting an aerosol concentration of five particles per liter of air, but involves expensive and delicate instruments. Other particle counters are manufactured by Met One Instrument, Inc, of Grants Pass, Oreg., Particle Measurement Systems, Inc., of Boulder, Colo., and Terra Universal Corp., of Anaheim, Calif.

Various detectors have been designed to detect airborne allergen particles and provide warning to sensitive individuals when the number of particles within an air sample exceeds a predetermined minimum value. Among these detectors are those described in U.S. Pat. Nos. 5,646,597, 5,969,622, 5,986,555, 6,008,729, 6,087,947, and 7,053,783, all to Hamburger et al. These detectors all involve direction of a light beam through a sample of environmental air such that part of the beam will be scattered by any particles in the air, a beam blocking device for transmitting only light scattered in a predetermined angular range corresponding to the predetermined allergen size range, and a detector for detecting the transmitted light.

For the purpose of detection of biological particles, including microbes, in air or water, it is of importance to devise an effective system to measure both particle size and fluorescence generated intrinsically by the microbes. A prior application, commonly owned by the assignee of the present application, improves upon previous designs by providing a sensor system that is capable of simultaneously measuring particle size and detecting the presence of intrinsic fluorescence from metabolites and other biomolecules, on a particle-by-particle basis, This prior art example comprises three main components: (1) a first optical system for measuring an individual particle size; (2) a second optical system to detect laser-induced intrinsic fluorescence signal from an individual particle; and (3) a data recording format for assigning both particle size and fluorescence intensity to an individual particle, and computer readable program code for differentiating microbes from non-microbes (e.g. inert dust particles).

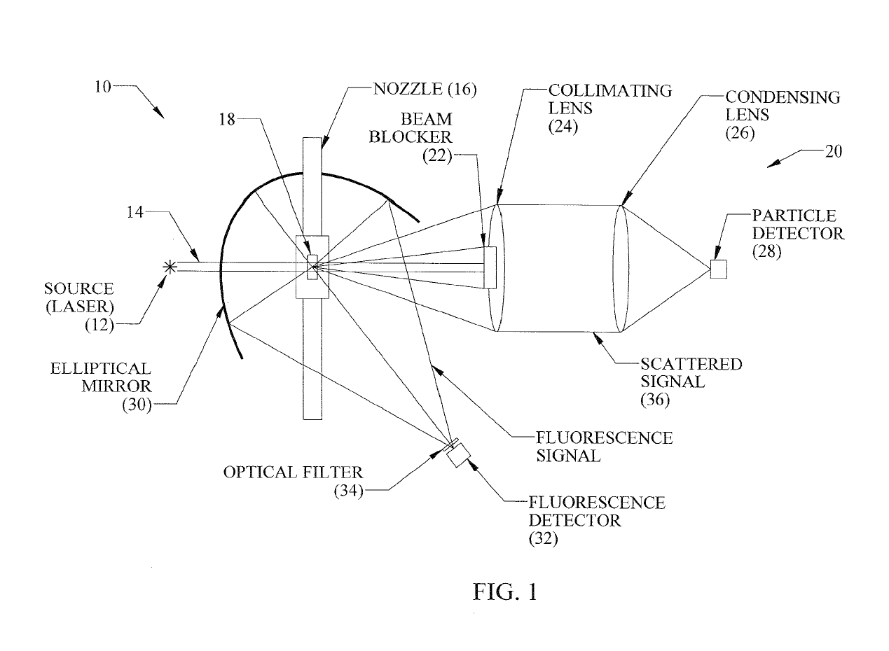

As shown in FIG. 1, the prior art system 10 includes a excitation source 12, such as a laser, LED or other light source, providing a beam of electromagnetic radiation 14 having a source wavelength. The excitation source is selected to have a wavelength capable of exciting intrinsic fluorescence from metabolites inside microbes. Environmental air (or a liquid sample) is drawn into the system through a nozzle 16 for particle sampling. Nozzle 16 has an opening 18 in its middle section (forming a sample cell) to allow the laser beam to pass through the particle stream. Directly downstream from the laser beam is a Mie scattering particle-size detector 20. Mie scattering particle-size detector 20 includes a beam blocker 22 in front of a collimator lens 24, and a condenser lens 26 for focusing a portion of the light beam 14 scattered by particles in the sample stream onto a particle detector 28. Off axis from the laser beam 14, an elliptical mirror 30 is placed at the particle-sampling region in such a way that the intersection of the incoming particle stream and the laser beam is at one of the two foci of the ellipsoid, while a fluorescence detector 32 occupies the other focus. In this optical design, the elliptical mirror 30 concentrates the fluorescence signal from biological particles and focuses it onto the fluorescence detector 32. An optical filter 34 is placed in front of the fluorescence detector to block scattered light and pass the induced fluorescence,

This system, however, has limitations in that the amount of fluorescence signal received by the fluorescence detector is small. The amount of noise accompanying this weak fluorescence signal makes it difficult to adequately process and amplify the data. Thus, there is a need for an improved design that efficiently gathers a greater amount of the fluorescence signal and allows a clearer fluorescence signal to be processed.

The present invention provides an improved sensor system which is capable of simultaneously measuring particle size and detecting the presence of intrinsic fluorescence from metabolites and other bio-molecules, on a particle-by-particle basis. The advantages of this detection scheme over the prior art are several. For one, it allows detailed analyses of data collected on each individual particle for characterizing the particle, such as intensity of fluorescence signal from a particle as a function of its cross-sectional area or volume, for the purpose of determining the biological status of the particles. Secondly, the present invention collects a greater amount of the fluorescence signal from a given particle, increasing the ability of the system to correctly identify biological particles.

The current invention comprises three main components: (1) a first optical system for measuring an individual particle size; (2) a second optical system to detect laser-induced intrinsic fluorescence signals from individual particles; and (3) a data recording format for assigning both particle size and fluorescence intensity to an individual particle, and computer readable program code for differentiating biological particles from non-biological particles (e.g. inert dust particles).

One embodiment of the present invention improves function of the second optical system by using a pair of elliptical mirrors with a pair of fluorescence detectors. The mirrors and detectors are positioned to collected fluorescence emission from the same particle as it is being measured for size. For each of the elliptical mirrors, one foci is at the intersection of the excitation light beam and one foci lies at the apex of the opposite facing elliptical mirror, where the fluorescence signal enters one of the fluorescence detectors. In another embodiment, an elliptical mirror and a spherical mirror are positioned to collect fluorescence emission from particles.

Further features and advantages of the present invention will be seen from the following detailed description, taken in conjunction with the accompanying drawings, wherein:

FIG. 1 is a schematic diagram of an optical system in accordance with the commonly owned prior art.

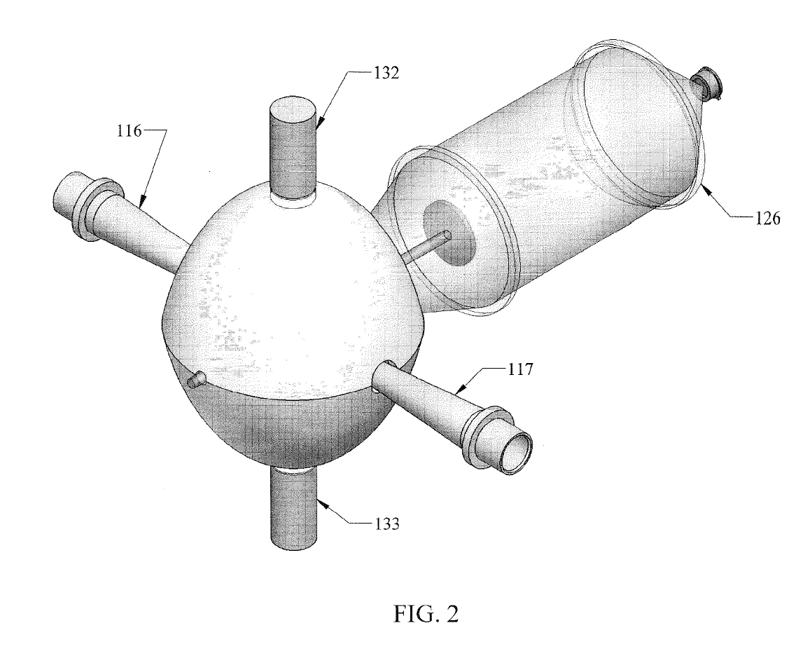

FIG. 2. is a plan view of the optical system in accordance with the present invention, for performing simultaneous measurements of particle size and fluorescence.

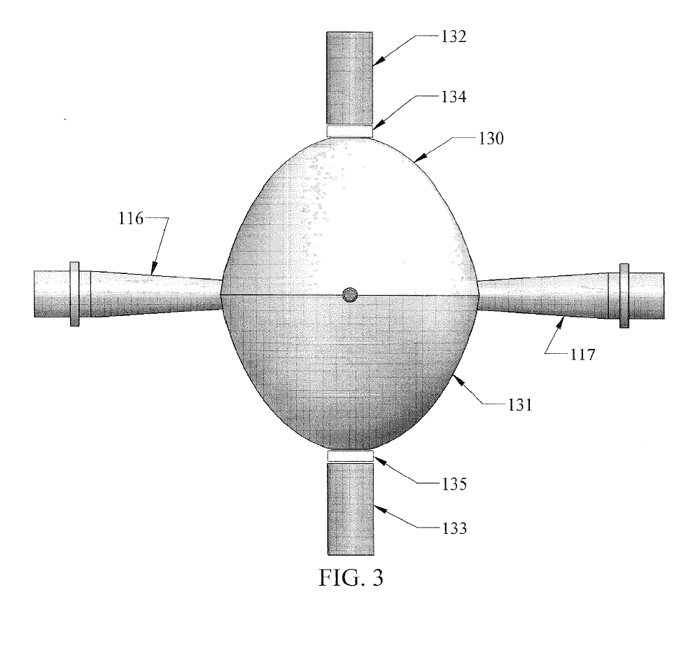

FIG. 3 is a front view of the optical system of FIG. 2.

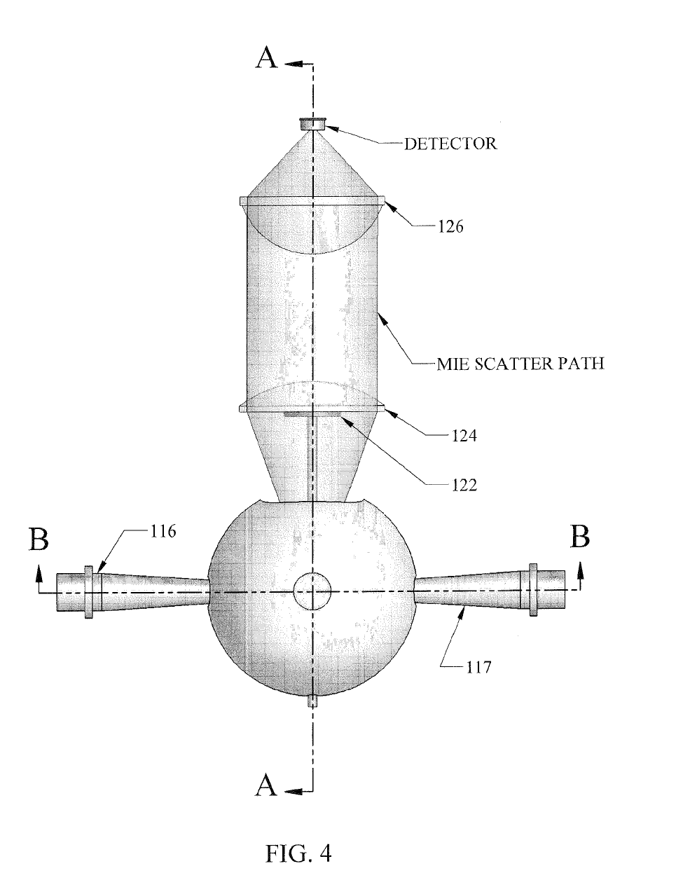

FIG. 4 is a top view of the optical system of FIG. 2.

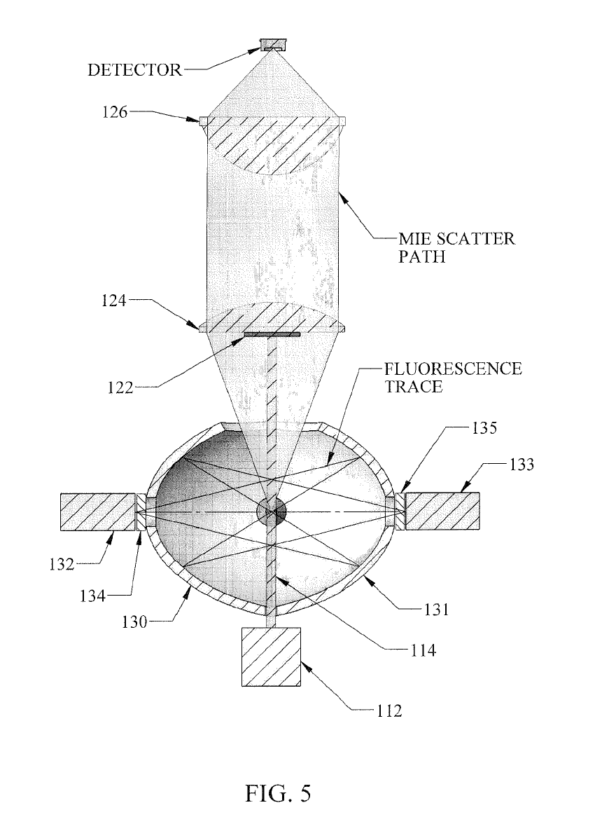

FIG. 5 is a sectioned view of the optical system, taken along section A-A of FIG. 4.

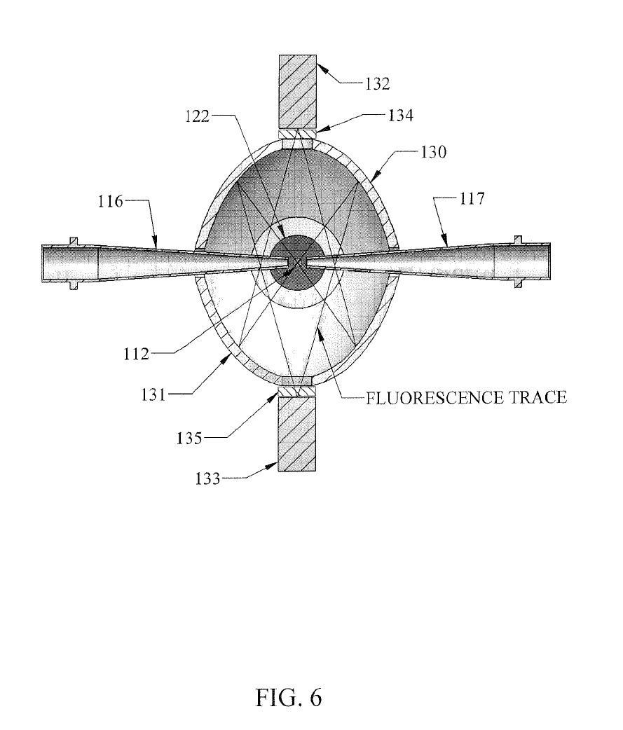

FIG. 6 is a sectioned view of the optical system, taken along section B-B of FIG. 4.

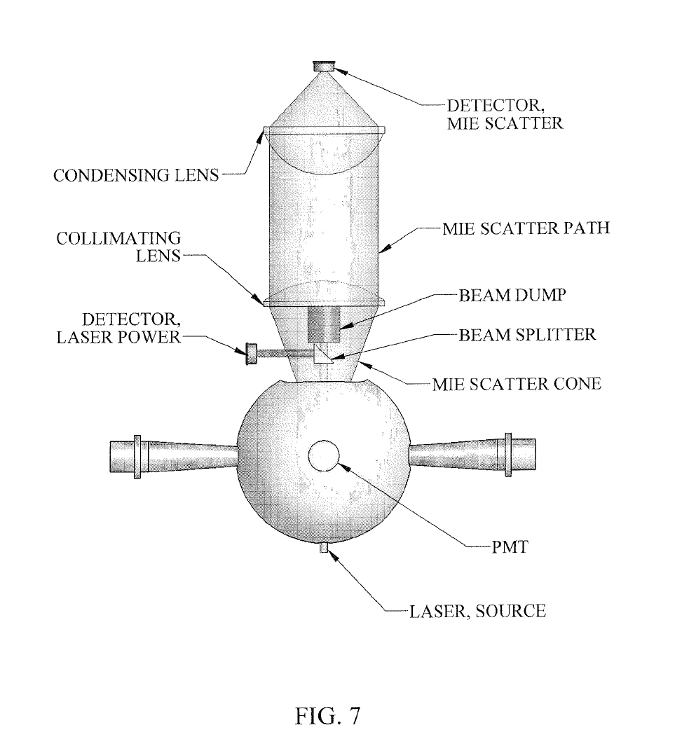

FIG. 7 illustrates an alternative embodiment of the invention.

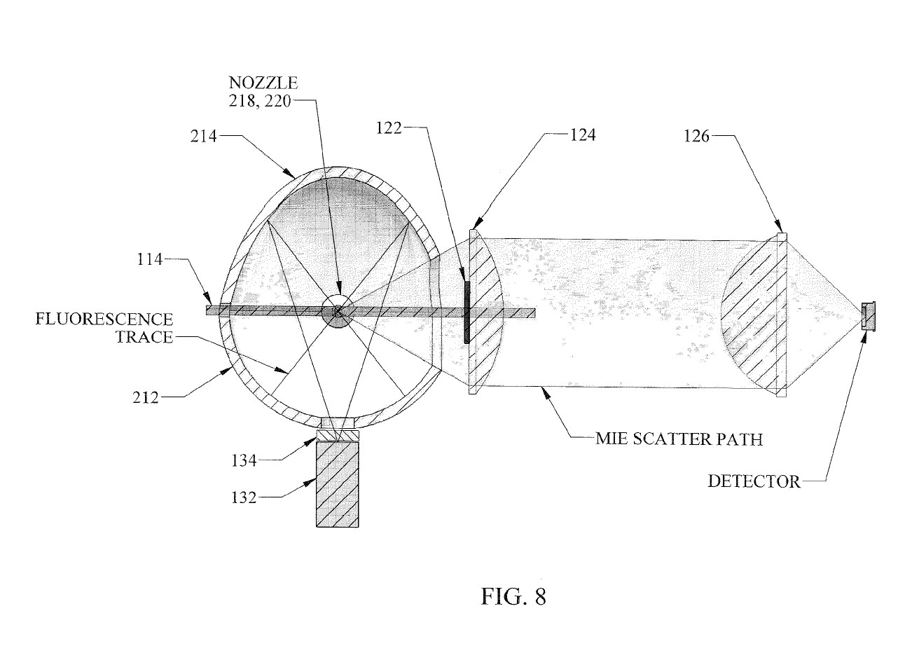

FIG. 8 illustrates yet another alternative embodiment of the invention comprising an elliptical and a spherical mirror.

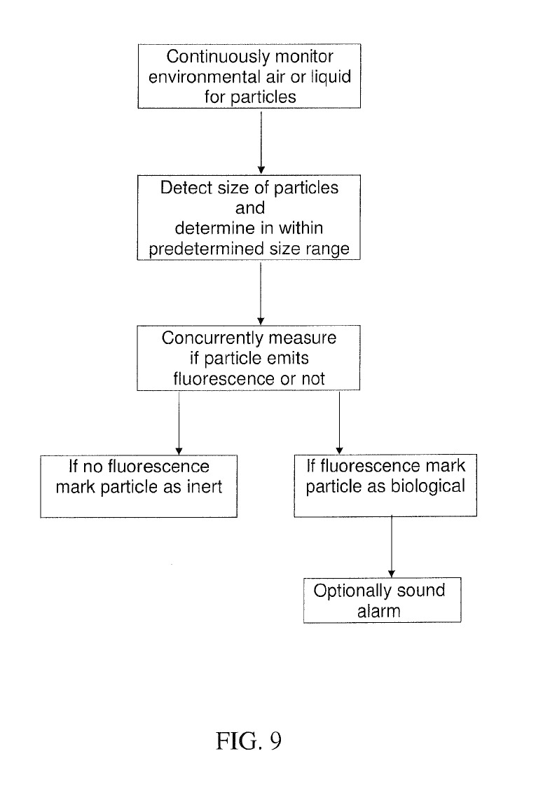

FIG. 9 is a block diagram of a measurement scheme in accordance with an embodiment of the present invention.

The methods and systems of the present invention can be used to detect and classify particles in liquids or gases by simultaneously measuring the size and any intrinsic fluorescence from the particles. The methods and systems of the present invention may further be used to differentiate and/or classify biological particles from inert particles.

The present invention is an optical system for a fluid particle detector system. This system is designed, for example, to detect airborne or liquid borne particles, such as biologic particles, in air or liquid media in industrial applications such as the food and pharmaceutical manufacturing industries and hospitals, as well as clean room and other controlled environment applications. The present invention may also be used in other applications, for example in buildings or in public transportation areas, to detect harmful levels of other airborne or liquid borne particles that may exist naturally, such as mold or bacteria, or which may have been accidentally, inadvertently or deliberately released. The systems of the present invention also may be used to detect bio-terrorist agents deliberately released by terrorists or others.

The term “fluid borne particles” as used herein means both airborne particles and liquid borne particles. Liquid borne particles include those in water or other liquid media. Fluid borne particles also includes those in air and other gases. As used here in “waterborne particles” include those in water and in liquids comprising water.

The term “microbial” particle, “biological” particle” or “biological” agent is defined as any microorganism, pathogen, or infectious substance, biological toxin, or any naturally occurring, bioengineered or synthesized component of any such microorganism, pathogen, or infectious substance, whatever its origin or method of production. Such biological agents include, for example, biological toxins, bacteria, viruses, rickettsiae, spores, fungi, and protozoa, as well as others known in the art.

The term “pathogen” as used herein refers to any airborne or liquid borne particle, biological agent or toxin, which could potentially harm or even kill humans exposed to such particles if present in sufficient quantities.

“Biological toxins” are poisonous substances produced or derived from living plants, animals or microorganisms, but also can be produced or altered by chemical means. A toxin, however, generally develops naturally in a host organism (i.e., saxitoxin is produced by marine algae), but genetically altered and/or synthetically manufactured toxins have been produced in a laboratory environment. Compared with microorganisms, toxins have a relatively simple biochemical composition and are not able to reproduce themselves. In many aspects, they are comparable to chemical agents. Such biological toxins are, for example, botulinum and tetanus toxins, staphylococcal enterotoxin B, tricothocene mycotoxins, ricin, saxitoxin, Shiga and Shiga-like toxins, dendrotoxins, erabutoxin b, as well as other known toxins.

The detector system of the present invention is designed to detect airborne or liquid borne particles and produce outputs indicating, for instance, the number of particles of each size within the range, which is detected in a sample, and indicate whether the particles are biologic or non-biologic. The system also may produce an alarm signal or other response if biological particles are detected and/or if the number of particles exceeds a predetermined threshold value, for example the number of detected particles is above a normal background level.

FIGS. 2-6 are illustrations of a preferred embodiment for a fluid particle detector system according to the present invention. As shown in FIGS. 5 and 6, the system includes an excitation source 112 such as a laser providing a beam of electromagnetic radiation 114 having a source wavelength. The excitation source is selected to have a wavelength capable of exciting intrinsic fluorescence from metabolites inside microbes and biological particles. The excitation source is also chosen to have a wavelength suitable for detecting Mie scattering from particles for the determination of particle size. Examples of suitable excitation sources include UV light and visible light radiation sources, such as UV light and visible e light lasers, LEDs and the like. By way of example, the excitation source 112 preferably operates in a wavelength of about 270 nm to about 410 nm, preferably about 350 nm to about 410 nm. A wavelength of about 270 nm to about 410 nm is chosen based on the premise that microbes and biological particles comprise three primary metabolites: tryptophan, which normally fluoresces at excitation wavelengths of about 270 nm with a range of about 220 nm-about 300 nm; nicotinamide adenine dinucleotide (NADH) which normally fluoresces at excitation wavelengths of about 340 nm (range about 320 nm-about 420 nm); and riboflavin which normally fluoresces at excitation wavelengths of about 400 nm (range about 320 nm-about 420 nm). In the case of bacterial endospores, dipicolinic acid (DPA) normally fluoresces at excitation wavelengths of about 400 nm (range about 320 nm-about 420 nm). Preferably, however, the excitation source 112 has a wavelength of about 350 to about 410 nm. This wavelength ensures excitation of two of the three aforesaid primary metabolites, NADH, and riboflavin, and DPA, in bio-particles but excludes excitation of interferences such as from diesel engine exhaust and other inert particles such as dust or baby powder. Thus, in a preferred embodiment the present invention makes a judicial selection of the wavelength or wavelength range of the excitation source 112, which retains the ability of exciting fluorescence from NADH and riboflavin (foregoing the ability to excite tryptophan) while excluding the excitation of interferents such as diesel engine exhaust. This step is taken to reduce false alarms generated by diesel exhaust (which can be excited by short UV wavelengths such as 266 nm light.

In the system illustrated in FIGS. 2-6 a fluid sample, (e.g. environmental air or a liquid sample) is drawn into the system through an entrance nozzle 116 for particle sampling. Nozzle 116 is aligned with exit nozzle 117, allowing the particle stream to pass through the path of the electromagnetic radiation 114. Directly downstream from the laser beam is a Mie scattering particle-size detector. The Mie scattering particle-size detector includes a beam blocker 122 in front of a collimator lens 124 and a condenser lens 126 for focusing a portion of the light beam 114 scattered by particles in the sample stream onto a particle detector (not shown).

Off axis from, and preferably orthogonal to, the electromagnetic radiation 114, a pair of elliptical mirrors 130, 131 are placed around the particle-sampling region inverted and facing each other in such a way that the intersection of the incoming particle stream and the laser beam is at one foci of each mirror, while a fluorescence detector 132, 133 (for example, a photo-multiplier tube) occupies the other foci of each mirror. The elliptical mirrors are preferably placed out of plane of the Mie scattering optics, such that they are orthogonal to the Mie scattering optics. This design utilizes the fact that a point source of light emanating from or passing through one of the two foci of an ellipsoid will be focused onto the other. In this optical design, the elliptical mirrors 130, 131 concentrate the fluorescence signal from microbe and focus it onto the fluorescence detectors 133 and 132 respectively. Preferably, the fluorescence detectors are photomultiplier tubes (PMTs). Optical filters 134, 135 may be placed in front of the fluorescence detectors to block the scattered light and pass the induced fluorescence.

The pair of elliptical mirrors form an enclosure around the particle detection area with openings for the nozzles 116, 117; the fluorescence detectors 132, 133; the electromagnetic radiation 114; and the Mie scatter cone (see FIG. 5). As shown in the figures, the nearest focus of a given elliptical mirror will be at the intersection of the particle stream and the laser beam. The farthest focus of a given mirror will, as stated above, be at the fluorescence detector. Ideally, this opposite focal point will lie at the apex of the opposing elliptical mirror. This is the case if both ellipsoid are identical and if the distance between the foci is equal to one third of the length of the major axis of the ellipsoid.

The beam blocker 122 is designed to absorb, stop and/or contain non-scattered elements of the beam of electromagnetic radiation 114, e.g. the laser beam, and may comprise light absorbent materials, such as vinyl, fluoroelastomers, metallic materials or the like, and/or geometries designed to collect and contain the radiation attached to a front surface of, for example, an optical element. Other features and considerations for the beam blocker 122 are disclosed in some of the earlier U.S. patents to Hamburger et al. listed above, and in PCT Application Serial No. PCT/US2006027638, incorporated herein by reference. Other features and considerations for the particle detector are disclosed in earlier commonly owned references, listed above, and the disclosures of which that are not inconsistent with the disclosure herein are incorporated herein by reference.

The present invention's use of Mie scattering also facilitates the placement of optical components for the detection of light induced fluorescence to concurrently examine individual particles for the presence of the metabolites NADH, riboflavin and other bio-molecules, which are necessary intermediates for metabolism of living organisms, and therefore exist in microbes and biological particles such as bacteria and fungi. If these chemical compounds exist in a bio-aerosol, they can be excited by photon energy and subsequently emit auto-fluorescence light which may be detected by an instrument based on the detection scheme outlined above. While this detection scheme is not capable of identifying the genus or species of microbes, and viruses may be too small and lack the metabolism for detection, this detection scheme's ability to simultaneously and for each particle determine the size of the particle and if it is biologic or inert indicates to the user the presence or absence of microbial contamination.

The double ellipsoidal mirror configuration has several advantages over the prior art. From FIG. 1, it is apparent that much of the fluorescent signal is not captured by the ellipsoidal mirror of the prior art. The signal received by the detector is weak and difficult to amplify without also amplifying signal noise as well. With the additional ellipsoidal mirror and detector, however, the two signals received by the detectors can be compared so that a signal processor can distinguish the fluorescence signal from the noise.

In an alternative embodiment, only one elliptical mirror is used. The elliptical mirror is rotated from its position according to the prior art (FIG. 1) until it faces 90° from the light source and is orthogonal to the Mie scattering optics. This requires a repositioning of the fluorescence detector to align with the elliptical mirror. This orthogonal configuration allows the construction of a smaller light box. This design also allows optimization of the optics and signal collection by reducing optical path overlap. The elliptical mirror may be built with the light box as single unit. This embodiment improves upon the prior art by providing a robust and compact design.

In other alternate embodiments, as shown in FIG. 7, an optical element may be placed before the collimating lens to reflect a portion of the unscattered excitation beam to a detector, such as a photo detector, to measure excitation source power. In preferred embodiment the optical element reflects a portion of the unscattered bean 90 degrees, although other degrees of reflection may also be used. Examples of suitable optical elements include, but are not limited to, mirrors and the like.

In addition, a spherical mirror may be used with this single elliptical mirror embodiment to capture fluorescence signals that are escaping from the embodiments of the prior art. The spherical mirror 212 would be placed opposite the elliptical mirror 214 with the intersection of the particle stream and the electromagnetic radiation at its focal point. See FIG. 8. The spherical mirror will reflect light back through the focal point and onto the elliptical mirror, which would then direct the light through an opening in the spherical mirror and into the fluorescence detector 216, which is shown in FIG. 8 as a PMT. This embodiment captures a greater amount of the fluorescence signal without the cost of an additional fluorescence detector. Similar to the preferred embodiment, the spherical mirror 212 and the elliptical mirror 214 would form an enclosure 218, with openings only for the nozzles 220, the fluorescence detector 216, and the Mie scatter cone. The elliptical mirror and the spherical mirror could be extended to the point where the two surfaces would intersect to make this enclosure as complete as possible. In this alternative design the spherical mirror is positioned such that the intersection of the particle stream and the laser beam is at the center of curvature of the sphere.

In another alternative embodiment, a different configuration for the particle size detection system is contemplated. In this embodiment, the collimating and condensing lenses are oriented 90° from one another. A optical element, e.g. a mirror, is situated to direct the electromagnetic radiation from the collimating lens into the condensing lens. A beam blocker may be placed before the collimating lens as described above, or alternatively, the optical element (e.g. a mirror) allows direct radiation from the excitation source to pass through into a light dump positioned behind the optical element. This may be done by placing an appropriately sized opening in the optical element, for instance. Alternatively, the light dump may be replaced with another detector. This detector could measure the amount of light received to be compared with the output of the light source and the amount received by the other detectors. This configuration allows for the construction of a smaller light box and a more compact system design.

The functionality of the simultaneous particle sizing and fluorescence measurement scheme of the present invention is depicted in FIG. 9. The principle of operation is as follows: an instrument continuously monitors the environmental air (or liquid) to measure the size of each individual airborne particle in real time and to concurrently determine whether that particle emits fluorescence or not. One or more thresholds are set for the fluorescence signal. If fluorescence signal falls outside set parameters, the particle is marked inert. The fluorescence signal thresholds include one or more selected from fluorescence signal intensity, fluorescence intensity as a function of particle cross-sectional area or a function of particle volume. If the fluorescence signal threshold exceeds or falls within one or more set threshold levels, the particle is marked biological. The combined data of particle size and fluorescence signal strength will determine the presence or absence of microbes on a particle-by-particle basis. Other features and considerations for fluorescence signal thresholds are disclosed in commonly owned U.S. patent application No. 12/268,366 to Morrell et al., the disclosure of which that are not inconsistent with the disclosure herein is incorporated herein by reference.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention. For example, the collimating and condensing lenses may be constructed as a single piece of the device. All such modifications and variations are intended to be included herein within the scope of this disclosure and the present invention and protected by the following claims.

1. A method of differentiating biological particles from inert particles in a fluid which comprises simultaneously measuring particle size and detecting intrinsic fluorescence from a particle, wherein fluorescence intensity is measured and assigned a value, and including the step of classifying the particle as either inert or biological based on particle size and fluorescence intensity, and wherein fluorescence is measured using two fluorescence detectors, and further wherein each of said two fluorescence detectors produce a signal, said signals being compared to determine relevant data for classifying particles.

2. canceled

3. canceled

4. canceled

5. canceled

6. canceled

7. A particle detector system, comprising:
sampling area including particles of various size to be measured;
a light source on one side of the sampling area for sending a beam of light through the sampling area;
a particle size detector positioned in the light path after the sampling area positioned to receive and detect a portion of forward scattered light scattered at various angles by the particles of various sizes, and producing an output including information on the size of particles in the light path;
a pair of opposite facing elliptical mirrors located in particle sampling region, wherein each elliptical mirror has one foci at a point where said light beam and said particles intersect and one foci on one of a pair of fluorescence detectors, and further wherein the elliptical mirrors are out of plane of the particle size detector.

8. The system of claim 7, further comprising a beam blocking device on an opposite side of the sampling area from said light source for blocking at least a portion of unscattered light emerging from the sampling area.

9. The system of claim 7, further comprising a collimating lens on an opposite side of the sampling area from said light source, an optical element positioned after the collimating lens for reflecting a portion of forward scattered light into a condensing lens which focuses said portion of forward scattered light into said particle size detector, wherein said unscattered light is stopped by a beam blocker in front of the condensing lens or passes through said optical element into a light dump.

10. canceled

11. The system of claim 7, wherein the light source emits light with a wavelength in the range of about 270 to about 410 nm.

12. The system of claim 7, further comprising a processing unit for processing particle size distribution and particle fluorescence at a given time, and displaying a signal on an output device.

13. canceled

14. The system of claim 7, further comprising computer readable program code for integrating detected particle size and detected intrinsic fluorescence.

15. A particle detector system, comprising:
sampling area including particles of various size to be measured;
a light source on one side of a sampling area for sending a beam of light through the sampling area;
a first detector positioned in the light path after the sampling area positioned to receive and detect a portion of forward scattered light scattered at various angles by said particles of various sizes, and producing an output including information on the size of particles in the light path within a predetermined size range;
a second detector positioned orthogonal to the beam of light for detecting intrinsic fluorescence from particles in the light path;
an elliptical mirror located in a particle sampling region such that an intersection of the sampling area and the light beam are at one foci of the ellipsoid, and the second detector is at the other foci; and
a spherical mirror positioned facing said elliptical mirror such that the intersection of the sampling area and the light beam are at the focus of the sphere.

16. The system of claim 15, further comprising a beam blocking device on an opposite side of the sampling area from said light source for blocking at least a portion of unscattered light emerging from the sampling area.

17. The system of claim 15, further comprising a collimating lens on an opposite side of the sampling area from said light source, a mirror for reflecting a portion of forward scattered light into a condensing lens which focuses said portion of forward scattered light into said particle size detector, wherein said unscattered light is not reflected into said condensing lens, wherein said unscattered light is stopped by a beam blocker in front of the condensing lens or passes through said optical element into a light dump.

18. The system of claim 7, wherein the fluorescence detectors are positioned orthogonal to the beam of light for detecting intrinsic fluorescence, and wherein said fluorescence detectors are positioned to opposite sides of said light beam.

19. The system of claim 11, wherein the light source is a UV laser, a visible light laser or a LED.

20. The system of claim 9, wherein the collimating lens and condensing lens are orientated 90 degrees from one another, and wherein the optical element is a mirror.

21. The system of claim 15, further comprising an alarm unit for providing a warning signal when a particle within a predetermined size range is detected which also fluoresces.

22. The system of claim 15, wherein the light source emits light with a wavelength in the range of about 270 to about 410 nm.

23. The system of claim 23, wherein the light source is a UV laser, a visible light laser or a LED.

24. The system of claim 15, further comprising a processing unit for processing particle size distribution and particle fluorescence at a given time, and displaying a signal on an output device.

25. The system of claim 15, further comprising computer readable program code for integrating detected particle size and detected intrinsic fluorescence.

26. The system of claim 17, wherein the collimating lens and condensing lens are orientated 90 degrees from one another.

27. The system of claim 15, wherein the elliptical and spherical mirrors are position around the particle sampling region such that the surface of the elliptical mirror and special mirror intersect.
